(19) United States
(12) Patent Application Publication
(10) Pub. No.: US 2010/0073615 A1
(43) Pub. Date: Mar. 25, 2010

(54) LIQUID CRYSTAL DISPLAY DEVICE AND FABRICATION METHOD THEREOF

(75) Inventors: Tomio YAGUCHI, Sagamihara (JP); Susumu Sasaki, Chiba (JP); Shoichi Uchino, Annaka (JP); Hitoshi Azuma, Yokohama (JP); Yasushi Nakano, Cyuo (JP); Takao Ebine, Ohtaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/563,216

(22) Filed: Sep. 21, 2009

(30) Foreign Application Priority Data
Sep. 22, 2008 (JP) 2008-242366

(51) Int. Cl. G02F 1/1333; G02F 1/13

(52) U.S. Cl. 349/122; 349/187

(57) ABSTRACT

A liquid crystal display device including a first substrate and a second substrate which are arranged to face each other via a liquid crystal layer, the first substrate and the second substrate each being formed of a resin base material, includes: an adhesive layer which is formed on the liquid crystal layer side of the first substrate to fix a liquid crystal drive layer formed with pixels in a matrix to the first substrate; and an under layer which is formed between a light shielding film and a colored filter layer both corresponding to each of the pixels and the second substrate and formed of a thin film material having a thermal expansion coefficient smaller than that of the second substrate.

The present application claims priority from Japanese applications JP 2008-242366 filed on Sep. 22, 2008, the content of which is hereby incorporated by reference into this application.

### BACKGROUND OF THE INVENTION

1. Field of the Invention

The present invention relates to a liquid crystal display device and a fabrication method thereof and more particularly to a liquid crystal display device in which pixels are formed above a pair of resin substrates which are arranged to face each other via a liquid crystal layer and a fabrication method thereof.

2. Background Art

Conventional liquid crystal display devices include a first substrate formed with pixel electrodes and the like, a second substrate arranged to face the first substrate, and a liquid crystal layer interposed between the first substrate and the second substrate. At the first substrate, in each of regions surrounded by, for example, a plurality of gate lines extending in the x-direction and arranged in parallel in the y-direction and a plurality of drain lines extending in the y-direction and arranged in parallel in the x-direction, a pixel is configured with at least a thin film transistor which is turned on with a scanning signal from the gate line and a pixel electrode supplied with a video signal from the drain line via the turned-on thin film transistor. With this configuration, each of the pixels can be controlled independently, whereby an image is displayed with the pixels.

On the other hand, a black matrix and color filters of R (red), G (green), and B (blue) corresponding to each of the pixels are formed at the second substrate, whereby color display can be performed depending on the amount of transmitted light transmitted through the color filters.

In the thus configured liquid crystal display devices, a glass substrate excellent in heat resistance has been generally used for the first and second substrates. In recent years, however, it becomes possible to lower the temperature in a step of forming a thin film transistor and in a step of forming a color filter. Therefore, a resin-made substrate (plastic substrate or resin substrate) which is light in weight and flexible compared with a glass substrate has come into use.

A liquid crystal display device using a resin substrate is disclosed in, for example, JP-A-8-248401. The liquid crystal display device disclosed in JP-A-8-248401 uses a plastic substrate instead of a glass substrate. JP-A-8-248401 discloses a technique for forming an inorganic thin film layer as a barrier layer at least on one electrode side surface of the plastic substrate for blocking the release of gas and suppressing moisture absorption.

### SUMMARY OF THE INVENTION

Along with the technique for lowering the temperature in the steps of forming a thin film transistor and a color filter, in the same step as in the conventional one, there is a technique for forming a semiconductor element side substrate (hereinafter, referred to as TFT side substrate) formed with thin film transistors and the like on a resin substrate and a color filter side substrate (hereinafter, referred to as CF side substrate) formed with a color filter layer on a resin substrate by forming a semiconductor element layer formed with thin film transistors (semiconductor elements) and pixel electrodes as pixel drive elements and a color filter layer above glass substrates, thereafter removing the glass substrates, and bonding the semiconductor element layer and the color filter layer on resin substrates using an adhesive.

When the semiconductor elements as the pixel drive elements are formed on the glass substrate, a silicon nitride layer or a silicon oxide layer, or a mixed layer thereof is formed as an under layer. The under layer cannot be removed when the semiconductor element layer is transferred (bonded) from the glass substrate to the resin substrate. Therefore, when the TFT side substrate and the CF side substrate are sealed together with a sealing material, the CF side substrate which is organic and the TFT side substrate which is inorganic are fixed together with a sealing material. Therefore, when the liquid crystal display device is heated under use conditions, there arises a problem that both or one of the TFT side substrate and the CF side substrate breaks because of the thermal expansion difference between the organic CF side substrate and the inorganic TFT side substrate.

Since the purpose of the technique disclosed in JP-A-8-248401 is to provide barrier properties due to an inorganic thin film layer, JP-A-8-248401 does not refer to the thermal expansion properties or strength of the inorganic thin film. Further, the technique disclosed in JP-A-8-248401 involves a problem that the flexibility of plastic substrates narrows the distance between the two substrates in a region without spacers which define the distance between them as the thickness of a liquid crystal layer to cause display unevenness.

The invention has been made to solve the above problems, and it is an object of the invention to provide a technique capable of preventing the failure of a liquid crystal display device caused by the thermal expansion difference between a TFT side substrate and a CF side substrate in the course of fabrication or use environment.

It is another object of the invention to provide a technique capable of improving the flexibility of a liquid crystal display device.

It is still another object of the invention to provide a liquid crystal display device improved in impact resistance or design selectivity for display screen.

In order to solve the above problem, according to a first aspect of the invention, a liquid crystal display device including a first substrate and a second substrate which are arranged to face each other via a liquid crystal layer, the first substrate and the second substrate each being formed of a resin base material, includes: an adhesive layer which is formed on the liquid crystal layer side of the first substrate to fix a liquid crystal drive layer formed with pixels in a matrix to the first substrate; and an under layer which is formed between a light shielding film and a colored filter layer both corresponding to each of the pixels and the second substrate and formed of a thin film material having a thermal expansion coefficient smaller than that of the second substrate.

In order to solve the above problem, according to a second aspect of the invention, a liquid crystal display device including a first substrate and a second substrate which are arranged to face each other via a liquid crystal layer, the first substrate and the second substrate each being formed of a resin base material, includes: a first adhesive layer which is formed on the liquid crystal layer side of the first substrate to fix a liquid crystal drive layer formed with pixels in a matrix to the first substrate; a second adhesive layer which is formed on the liquid crystal layer side of the second substrate to fix a color filter layer formed with a light shielding film and a colored filter layer both corresponding to each of the pixels to the second substrate; and an under layer which is formed on the liquid crystal layer side of the color filter layer and formed of a thin film layer having a thermal expansion coefficient smaller than that of the second substrate.

In order to solve the above problem, according to a third aspect of the invention, in the liquid crystal display device according to the first or second aspect of the invention, the under layer is formed of a thin film layer having a thermal expansion coefficient of from 3 to 15 ppm/° C.

In order to solve the above problem, according to a fourth aspect of the invention, in the liquid crystal display device according to any of the first to third aspects of the invention, a sealing material which fixes the first substrate to the second substrate and the under layer are formed so as to overlap with each other, at least a part of the sealing material being in close contact with the under layer annularly.

In order to solve the above problem, according to a fifth aspect of the invention, in the liquid crystal display device according to any of the first to fourth aspects of the invention, the under layer is resistant to hydrofluoric acid.

In order to solve the above problem, according to a sixth aspect of the invention, in the liquid crystal display device according to any of the first to fifth aspects of the invention, the under layer is a thin film layer formed of an inorganic material.

In order to solve the above problem, according to a seventh aspect of the invention, in the liquid crystal display device according to the sixth aspect of the invention, the under layer is a thin film layer formed of nitride.

In order to solve the above problem, according to an eighth aspect of the invention, in the liquid crystal display device according to any of the first to seventh aspects of the invention, the under layer is a thin film layer formed of a material containing oxygen.

In order to solve the above problem, according to a ninth aspect of the invention, in the liquid crystal display device according to any of the first to eighth aspects of the invention, the under layer is formed of a thin film layer having a thickness of 300 nm or more.

In order to solve the above problem, according to a tenth aspect of the invention, a method for fabricating a liquid crystal display device including a first substrate and a second substrate which are arranged to face each other via a liquid crystal layer, the first substrate and the second substrate each being formed of a resin base material, the method includes: forming a light shielding film and a colored filter layer both corresponding to a pixel and a protective film above a first base material having a heat resistance greater than that of the resin base material; forming a protective base material which supports and protects the light shielding film, the colored filter layer, and the protective film on an upper surface side of the first base material; removing the first base material chemically and/or mechanically; fixing the light shielding film, the colored filter layer, and the protective film from which the first base material is removed to the first substrate via an adhesive layer; and removing the protective base material from above the light shielding film, the colored filter layer, and the protective film which are fixed to the first substrate.

In the liquid crystal display device according to the aspects of the invention, it is possible to prevent the failure of the liquid crystal display device caused by the thermal expansion difference between the semiconductor element side substrate and the color filter side substrate in the course of fabrication or use environment.

As a result, since the flexibility of the liquid crystal display device can be improved, it is possible to provide the liquid crystal display device improved in impact resistance or design selectivity for display screen.

Other advantages of the invention will be apparent from the entire description of the specification.

### BRIEF DESCRIPTION OF THE DRAWINGS

FIG. 1 is a plan view for explaining the schematic configuration of a liquid crystal display device of Embodiment 1 of the invention;

FIG. 2 is a plan view for explaining the schematic configuration of a pixel in the liquid crystal display device of Embodiment 1 of the invention;

FIG. 3 is a cross sectional view taken along the line B-B' in FIG. 2;

FIG. 4 is a cross sectional view for explaining the detailed configuration of the liquid crystal display device of Embodiment 1 of the invention;

FIG. 5 is a plan view of a color filter side substrate of Embodiment 1 of the invention;

FIGS. 6A to 6D are flow sheets for explaining an embodiment of a fabrication method of a TFT side substrate of Embodiment 1 of the invention;

FIG. 7 is a cross sectional view for explaining the detailed configuration of a liquid crystal display device of Embodiment 2 of the invention;

FIGS. 8A to 8D are flow sheets for explaining an embodiment of a fabrication method of a color filter side substrate of Embodiment 2 of the invention;

FIG. 9 shows an experiment result of the breakage rate of liquid crystal display devices when heated at a heat curing temperature of a liquid crystal cell seal;

FIG. 10 is a cross sectional view for explaining the schematic configuration of a liquid crystal display device of Embodiment 3 of the invention; and

FIG. 11 is a plan view for explaining the arrangement position of column spacers of the liquid crystal display device of Embodiment 3 of the invention.

### DESCRIPTION OF THE PREFERRED EMBODIMENTS

Hereinafter, embodiments to which the invention is applied will be described with reference to the drawings. In the following description, the same constituent elements are denoted by the same reference numerals, and the repetitive description thereof is omitted.

### Embodiment 1

### Overall Configuration

FIG. 1 is a plan view for explaining the schematic configuration of a liquid crystal display device of Embodiment 1 of the invention.

As shown in FIG. 1, the liquid crystal display device of Embodiment 1 has a liquid crystal display panel pnl including a semiconductor element side substrate (TFT side substrate or first substrate) pl1 formed with pixel electrodes and the like, a color filter side substrate (CF side substrate or second substrate) pl2 formed with later-described color filters and black matrix (light shielding film) and arranged to face the TFT side substrate pl1, and a not-shown liquid crystal layer interposed between the TFT side substrate pl1 and the CF side substrate pl2. The liquid crystal display panel pnl and a not-shown backlight unit serving as a light source are combined together, whereby the liquid crystal display device is completed. The TFT side substrate pl1 and the CF side substrate pl2 are fixed together with a liquid crystal cell seal (sealing material) sl which is annularly applied on the periphery portion of the CF side substrate pl2, and also liquid crystal which is interposed between the two substrates pl1 and pl2 is sealed with the sealing material. In the following description, the liquid crystal display panel pnl is also described as the liquid crystal display device.

The TFT side substrate pl1 and the CF side substrate pl2 are formed of well-known plastic substrates (resin substrates) having insulating property. Especially in the liquid crystal display device of Embodiment 1, as will be described later, a TFT layer of a thin film transistor tr, a pixel electrode px, and the like formed above a glass substrate is bonded on a resin base material of the TFT side substrate. Accordingly, since the process temperature can be raised compared with the case where the TFT layer is directly formed above a resin-made substrate, a later-described gate insulating film can be densified. Therefore, the reliability of the thin film transistor tr can be improved. In addition, since a plastic substrate (resin base material) is used, a liquid crystal display device which is light in weight and excellent in impact resistance can be provided.

In the liquid crystal display device of Embodiment 1, a region inside the region where the liquid crystal is filled and formed with display pixels (hereinafter simply referred to as pixels) forms a display region ar. Accordingly, a region not formed with the pixels and not concerned with displaying is not the display region ar even inside the region where the liquid crystal is filled.

In the liquid crystal display device of Embodiment 1 shown in FIG. 1, gate lines gl extending in the x-direction in the drawing and arranged in parallel in the y-direction are formed on a surface of the TFT side substrate pl1 on a liquid crystal side inside the display region ar. In addition, drain lines dl extending in the y-direction in the drawing and arranged in parallel in the x-direction are formed.

Rectangular regions surrounded by the drain lines dl and the gate lines gl constitute a region formed with the pixels, whereby the pixels are arranged in a matrix in the display region ar. As shown in an enlarged view A′, for example in a circle A portion in FIG. 1, the pixel includes the thin film transistor tr, the pixel electrode px, and a common electrode ct. The thin film transistor tr is turned on with a scanning signal from the gate line gl. The pixel electrode px is supplied with a video signal from the drain line dl via the turned-on thin film transistor tr. The common electrode ct is connected to a common line cl and supplied with a reference signal which has a potential serving as a reference for the potential of the video signal. Although the common electrode ct shown in the enlarged view A′ is configured such that the reference signal is input to the common electrode ct which is independently formed for each of the pixels via the common line cl, this is not restrictive. As will be described later, the common electrode ct may be formed such that the common electrodes ct in the pixels adjacently arranged in the x-axis direction are directly connected with one another to input with the reference signal from one end of right and left ends in the x-axis direction (ends of the first substrate) or from both ends via the common line cl.

In Embodiment 1, each of the drain lines dl and gate lines gl extends over the liquid crystal cell seal sl at, for example, the lower end thereof and is connected with a flexible printed board fpc in a terminal region trm at the lower end portion in FIG. 1. In Embodiment 1, a driver IC (composed of scanning signal drive circuits, video signal drive circuits, and the like) for the liquid crystal display device is mounted on a not-shown drive circuit board. Output of the driver IC is output to each of the drain lines dl and gate lines gl via the flexible printed board fpc.

In the liquid crystal display device of Embodiment 1, the terminal region trm is formed in a region outside the region where the TFT side substrate pl1 and the CF side substrate pl2 which face each other via a liquid crystal layer lc are overlapped with each other.

The driver IC may be mounted above the TFT side substrate pl1, that is, on a TFT under layer uc1, and each of the drain lines dl and gate lines gl extended over the liquid crystal cell seal sl may be connected to an output terminal of the driver IC. In this case, a driving signal for the driver IC is input via the flexible printed board fpc connected to the terminal region trm. The driver IC composed of scanning signal drive circuits and video signal drive circuits can be configured as semiconductor devices each composed of a semiconductor chip and can be mounted on the surface of the first substrate. However, for example, one side of a semiconductor device which is formed by a tape carrier method or a COF (Chip On Film) method may be connected to the TFT side substrate. Circuits may be integrally formed on the TFT side substrate.

(Configuration of Pixel)

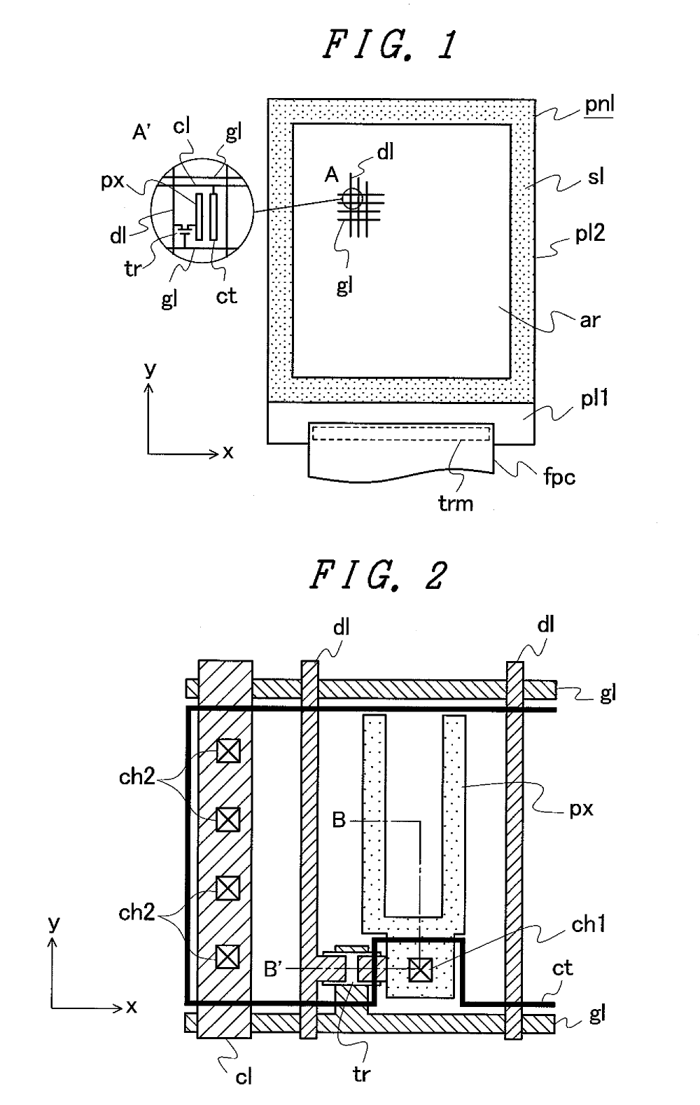

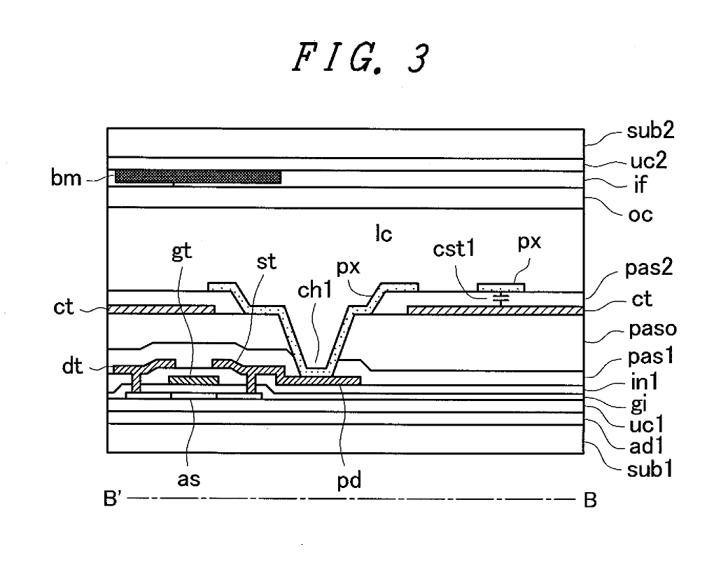

FIG. 2 is a plan view for explaining the schematic configuration of a pixel in the liquid crystal display device of Embodiment 1. FIG. 3 is a cross sectional view taken along the line B-B′ in FIG. 2. Thin films shown below can be formed by a well-known photolithography technique, and therefore the detailed description of the forming method is omitted. For simplifying the description, an alignment films, a polarizer, and the like which are formed on the TFT side substrate pl1 and the CF side substrate pl2 are omitted. Further in FIG. 2, a black matrix bm, a colored filter layer if, and the like which are formed on the CF side substrate pl2 are omitted.

As shown in FIG. 2, the gate lines gl and the drain lines dl are formed in parallel with a relatively large distance on the surface (upper surface) of the TFT side substrate pl1 on the liquid crystal layer lc side.

In the region surrounded by the gate lines gl and the drain lines dl, the common electrode ct formed of a transparent conductive material such as, for example, ITO (Indium-Tin-Oxide) is formed. The transparent electrode ct is overlapped with the common line cl at the side portion thereof on the common line cl side and electrically connected to the common line cl via contact holes ch2. Although the description will be made on the case where ITO is used for a transparent conductive film, this is not restrictive. A well-known ZnO-type transparent conductive film may be used.

As shown in FIG. 3, an adhesive layer ad1 which bonds together the TFT layer formed on a not-shown glass substrate and including layers on and above the TFT under layer uc1 in the drawing and a TFT side resin base material sub1 made of resin are formed on the surface (surface on the liquid crystal layer lc side) of the TFT side substrate pl1. As will be described later, the TFT under layer uc1 having a thickness of 300 nm is formed on the adhesive layer ad1. The TFT under layer uc1 has an advantage of blocking the mixing of ions such as of Na (sodium) or K (potassium) from the TFT side resin base material sub1 or the adhesive layer ad1 to the thin film transistor tr. As the TFT under layer uc1, for example, a thin film having a structure in which a thin film layer formed of silicon nitride or the like and a thin film layer formed of silicon oxide or the like are stacked in this order from the TFT side resin base material sub1 side can be used, but this is not restrictive. The thickness of the TFT under layer uc1 is not limited to 300 nm but may be 300 nm or more.

A non-crystalline semiconductor layer as formed of, for example, amorphous silicon is formed on the TFT under layer uc1. The semiconductor layer as serves as a semiconductor layer of the thin film transistor tr. In addition to the forming region of the thin film transistor tr, the semiconductor layer as is also formed, for example, under the drain line dl and under a connecting portion which electrically connects the drain line dl with a drain electrode dt of the thin film transistor tr (these semiconductor layers are hereinafter referred to as amorphous silicon layers for distinguishing from the semiconductor layer as). The amorphous silicon layer is formed such that a difference in level can be reduced in, for example, the drain line dl.

An insulating film gi is formed on the semiconductor layer as so as to cover the semiconductor layer as. The insulating film gi functions as a gate insulating film of the thin film transistor tr in the forming region of the thin film transistor tr. The thickness of the insulating film gi, and the like can be set corresponding to the gate insulating film. A gate electrode gt is formed on the upper surface of the insulating film gi in a portion overlapped with the semiconductor layer as. An inter-layer insulating film in1 is formed on the gate electrode gt. For example, silicon oxide (SiO₂), silicon nitride (SiN), or the like is preferable for the inter-layer insulating film in1.

The drain lines dl are formed so as to extend in the y-direction in FIG. 2. The drain line dl has an extended portion extended to the thin film transistor tr side at a part thereof. The extended portion is connected to a drain region formed in the semiconductor layer as via a contact hole formed through the insulating film gi and the inter-layer insulating film in1. The drain line dl intersects the gate line gl in a region in the vicinity of the thin film transistor tr via the insulating film gi and the amorphous silicon layer.

A source electrode st which is formed simultaneously when the drain lines dl and the drain electrode dt are formed is formed at a position facing the drain electrode dt on the semiconductor layer as. The source electrode st is connected to a source region formed in the semiconductor layer as via the contact hole formed through the insulating film gi and the inter-layer insulating film in1. The source electrode st has an extended portion slightly extended from a portion above the semiconductor layer as to the pixel region side. The extended portion reaches a pad pd connected to the pixel electrode px which will be described later.

A protective film which is formed of an inorganic insulating film pas1 formed of an inorganic compound and covering the thin film transistor tr and an organic insulating film paso functioning as a planarization film is formed on the drain electrode dt and the source electrode st, that is, on the thin film transistor tr. The inorganic insulating film pas1 protects the thin film transistor tr against the liquid crystal or an alkali component of the organic insulating film paso. The inorganic insulating film pas1 is formed of, for example, a silicon nitride (SiN) film or the like as an inorganic material and formed on the entire surface of the thin film transistor tr. The organic insulating film paso is formed on the inorganic insulating film pas1 (the liquid crystal side lc of the substrate) by a well-known spin coating method. The organic insulating film paso is formed of, for example, a photosensitive organic material such as polyimide or acrylic resin and planarizes the irregularities on the upper surface of the TFT side substrate pl1 caused by the formation of the thin film transistor tr, the gate lines gl, the drain lines dl, the common lines cl, and the like. In the TFT side substrate pl1 of the liquid crystal display device of Embodiment 1, the inorganic insulating film pas1 and the organic insulating film paso constitute the protective film.

The common electrode ct is formed on the organic insulating film paso. A capacitor insulating film pas2 is formed on the common electrode ct. The contact hole ch1 reaching the pad pd is formed through the capacitor insulating film pas2, the organic insulating film paso, and the inorganic insulating film past, whereby the pixel electrode px formed on the capacitor insulating film pas2 is electrically connected with the source electrode st.

As described above, in the liquid crystal display device of Embodiment 1, the pixel electrode px is arranged via the capacitor insulating film pas2 formed on the common electrode ct. In the thus formed liquid crystal display device (lateral electric field type liquid crystal display device), the pixel electrode px and the common electrode ct generally also function as a pair of electrodes for forming a holding capacitor cst1. That is, the capacitor insulating film pas2 is used as an inter-layer insulating film formed between the pixel electrode px and the common electrode ct, thereby realizing insulation between the pixel electrode px and the common electrode ct. At the same time, the pixel electrode px and the common electrode ct realize a holding capacitor necessary for holding pixel charge.

On the other hand, a color filter under layer uc2 having a thickness of 300 nm is formed on the surface (surface on the liquid crystal layer lc side) of a color filter side resin base material sub2 made of resin. As will be described later, although a silicon nitride thin film can be used as the color filter under layer uc2, for example, this is not restrictive. The black matrix bm is formed on the color filter under layer uc2 (lower side in the drawing) along, for example, the outer periphery of each of the pixels. The thickness of the color filter under layer uc2 is not limited to 300 nm but may be 300 nm or more.

Any of the R, G, and B colored filter layers if corresponding to the pixels is formed on the black matrix bm (surface on the liquid crystal layer lc side or lower side in the drawing). In the liquid crystal display device of Embodiment 1 in this case, the outer periphery portion of the colored filter layer if formed in each of the pixels is overlapped with the black matrix bm. That is, the colored filter layer if is formed so as such that the colored filter layer if of an adjacent pixel covers the black matrix bm. This configuration prevents the creation of a gap between the black matrix bm and the colored filter layer if, thereby preventing the occurrence of light leakage. In Embodiment 1, although the colored filter layer if is formed in each of the pixels, this is not restrictive. The colored filter layers if may be arranged in stripe patterns of red, green, and blue, and each of the stripes may be in parallel with the drain line dl, for example.

An overcoat layer oc is formed on the colored filter layer if, and the overcoat layer oc is formed by applying, for example, acrylic resin.

In the liquid crystal display device of Embodiment 1 shown in FIGS. 2 and 3, although the case has been described in which two linear electrodes are formed as the pixel electrode px by using the transparent conductive film serving as the pixel electrode px for simplifying the description, this is not restrictive. Two or more linear electrodes may be formed in the pixel region by using the transparent conductive film to use as the pixel electrode px. In addition, the forming direction of the linear electrode is not limited to the forming direction of the drain line dl but may be the forming direction of the gate line gl or may be tilted by 45° or −45° from the forming direction of the drain line dl. Further, a planar electrode may be connected to the source electrode st of the thin film transistor tr, and the linear electrode may be connected to the common line cl.

(Detailed Overall Configuration)

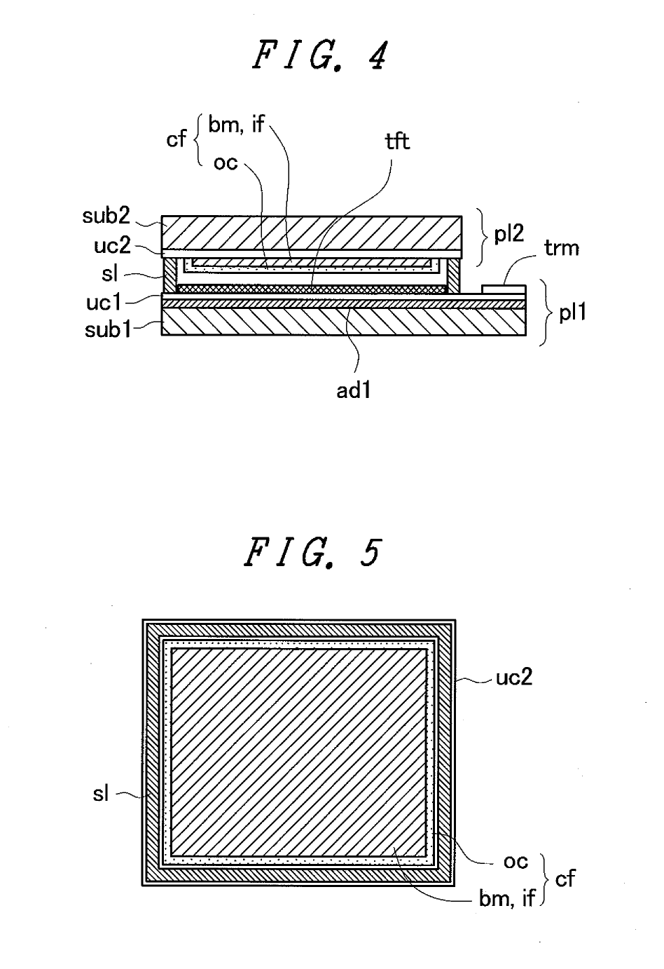

FIG. 4 is a cross sectional view for explaining the detailed configuration of the liquid crystal display device of Embodiment 1 of the invention. FIG. 5 is a plan view of the color filter side substrate of Embodiment 1 of the invention. Especially the plan view shown in FIG. 5 is a plan view of the surface on the liquid crystal side, that is, on the side facing the TFT side substrate pl1. In the following description, the semiconductor layer as, the insulating film gi, the inter-layer insulating film in1, the gate electrode gt, the drain electrode dt, the source electrode dt, the inorganic insulating film pas1, the organic insulating film paso, the common electrode ct, the capacitor insulating film pas2, the pixel electrode px, the drain line dl, the gate line gl, the not-shown alignment film, and the like formed on the TFT under layer uc1 of the TFT side resin base material sub1, which has been described in the above “Configuration of Pixel”, are simply referred to as the TFT layer (liquid crystal drive layer) tft. Further, the black matrix bm, the colored filter layer if, the overcoat layer oc, the not-shown alignment film, and the like formed on the color filter under layer uc2 (lower side in the drawing) are simply referred to as a color filter layer cf.

In the liquid crystal display device of Embodiment 1 of the invention shown in FIG. 4, the CF side substrate pl2 in which the color filter layer cf is formed on the color filter side resin base material sub2 and the TFT side substrate pl1 which is obtained by transferring (bonding) the TFT layer tft formed on the not-shown glass base material to the TFT side resin base material sub1 are bonded together with the liquid crystal cell seal (sealing seal) sl, whereby a liquid crystal cell (liquid crystal display device) is formed.

As described in the above “Configuration of Pixel”, in the liquid crystal display device of Embodiment 1 shown in FIG. 4, the adhesive layer ad1 is formed on the surface of the TFT side resin base material sub1, that is, on the surface on the liquid crystal layer lc side, the TFT under layer uc1 is formed on the adhesive layer ad1, and the TFT layer tft is formed on the TFT under layer uc1. The liquid crystal cell seal sl is directly formed on the TFT under layer uc1. That is, the liquid crystal cell seal sl is in direct contact with the TFT under layer uc1. The terminal region is formed on the TFT under layer uc1. Each of the drain lines dl and gate lines gl of the TFT layer tft extended over the liquid crystal cell seal sl and the like are connected to the terminal region trm.

The color filter under layer uc2 is formed on the surface of the color filter side resin base material sub2, that is, on the surface on the liquid crystal layer lc side. The color filter layer cf formed of the black matrix bm, the colored filter layer if, the overcoat layer oc, and the like is formed on the color filter under layer uc2. In Embodiment 1, the liquid crystal cell seal sl is formed on the color filter under layer uc2 (lower side in the drawing). At least a part of the liquid crystal cell seal sl is in direct contact with the color filter under layer uc2 annularly. That is, since the not-shown alignment film which is formed on the upper surface of the second substrate and in contact with the liquid crystal to align the same is thin compared with the color filter layer cf, the liquid crystal cell seal sl can be formed on the alignment film. In Embodiment 1, however, at least a part of the liquid crystal cell seal sl is in direct contact with the color filter under layer uc2 annularly. With such a configuration, the influence of contraction or expansion of the color filter side resin base material sub2 which is the base material of the CF side substrate pl2 on the color filter layer cf is suppressed to a minimum.

In Embodiment 1, before the color filter layer cf is formed on the color filter side resin base material sub2, a silicon nitride film having a thickness of 300 nm is formed as the color filter under layer uc2 only on the surface facing the TFT substrate pl1 by, for example, plasma-assisted reactive sputtering. Although the silicon nitride film is slightly colored, transparency can be improved by adding oxygen as needed in deposition. As shown in FIG. 5, a region where the color filter under layer uc2 is formed is substantially the entire surface of the color filter side resin base material sub2 and is wider than the color filter layer cf. The liquid crystal cell seal (sealing seal) sl is formed so as to overlap the region where the color filter under layer uc2 is formed without the color filter layer cf. As the liquid crystal cell seal (sealing seal) sl, for example, such a type that is cured by both ultraviolet irradiation and heat treatments can be used, but this is not restrictive.

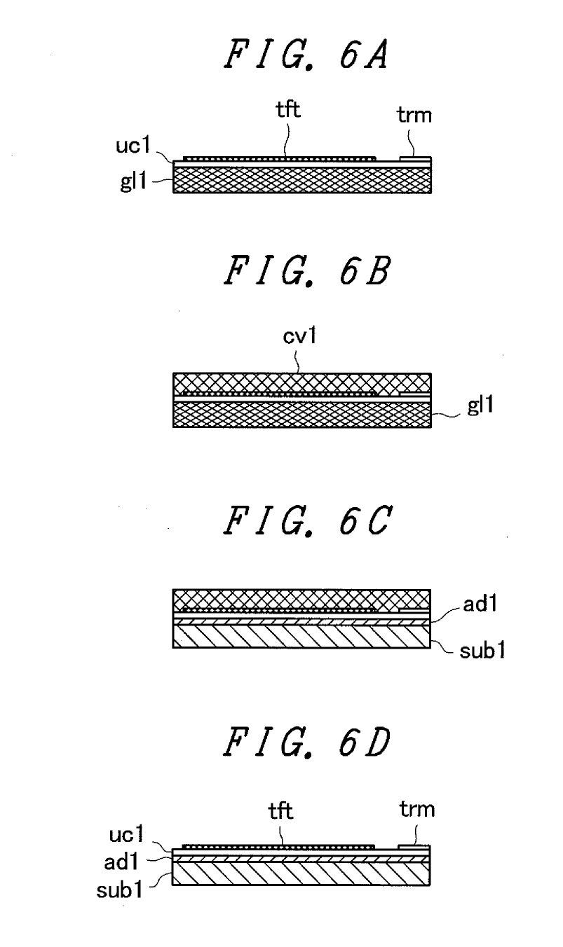

FIGS. 6A to 6D show flow sheets for explaining an embodiment of a fabrication method of the TFT side substrate of Embodiment 1 of the invention. Hereinafter, the fabrication method will be described in the order of steps based on FIGS. 6A to 6D. Since thin films including electrodes can be formed in each of the steps by a well-known photolithography technique, the detailed description thereof is omitted.

Step 1. (FIG. 6A)

At present, a semiconductor element capable of providing necessary and sufficient characteristics cannot be directly formed on a resin substrate. In Embodiment 1 of the invention, therefore, a stacked film made of silicon nitride and silicon oxide is first formed on a glass base material (glass base material for forming TFT) gl1 as the under layer (TFT under layer) uc1 when the TFT layer tft is formed. Next, the TFT layer tft is formed on the TFT under layer uc1 using an existing high temperature process. As described above, in the liquid crystal display device of Embodiment 1 in this case, the terminal region trm is to be formed in the region outside the region where the TFT side substrate pl1 and the CF side substrate pl2 are overlapped with each other. Therefore, the terminal region trm is formed in the right end portion of the glass base material gl1 in the drawing.

Step 2. (FIG. 6B)

Next, a thin film layer serving as a TFT layer protective base material cv1 is formed on the upper surface side of the glass base material gl1 in the drawing so as to cover the TFT layer tft. Next, the glass base material gl1 is removed by chemical polishing using, for example, an etching solution mainly containing hydrofluoric acid by using the TFT layer protective base material cv1 as a supporting material. In this case, since the TFT under layer uc1 is resistant to hydrofluoric acid, the glass base material gl1 is removed in chemical polishing. The removing of the glass base material gl1 is not limited to chemical polishing, but mechanical polishing or a polishing method combining mechanical polishing and chemical polishing may be used, for example. The TFT under layer uc1 is not limited to the stacked film made of silicon nitride and silicon oxide but may be other film material although a material which is resistant to hydrofluoric acid is preferable.

Step 3. (FIG. 6C)

Next, the TFT layer tft after removing the glass base material gl1 is bonded to the TFT side resin base material sub1 with the adhesive layer ad1 in a state of being supported by the TFT layer protective base material cv1. With the step 3, the TFT side resin base material sub1 constitutes the base material of the TFT side substrate pl1.

Step 4. (FIG. 6D)

Next, the TFT layer protective base material cv1 formed on the TFT layer tft is peeled, whereby the transfer of the TFT layer tft formed above the glass base material gl1 to the TFT side resin base material sub1 is completed. In this manner, in Embodiment 1, the TFT layer tft is transferred together with the stacked film to the TFT side resin base material sub1 upon transfer.

The TFT side substrate pl1 formed in the steps as described above and the CF side substrate pl2 are fixed together with the liquid crystal cell seal (sealing seal) sl which is the type that is cured by both ultraviolet irradiation and heat treatments as described above. At the time of heat curing, a heat treatment has to be performed at 120° C. for 30 min.

In the liquid crystal display device (the liquid crystal cell having the structure shown in FIG. 1) of Embodiment 1 in this case, the breakage of the cell has not occurred. However, in a liquid crystal cell fabricated without forming the color filter under layer uc2, the CF side substrate pl2 is deformed along with the heat treatment in a state of being heated up to about 100° C., and then the liquid crystal cell is cracked and broken. There is a sealing material which can be cured only with ultraviolet irradiation. However, it can be easily estimated that the use environment of a liquid crystal cell is at 80° C. or more especially in a display device of portable equipment. Therefore, even when the cell does not break in the fabrication steps, the cell has a high risk of breaking under an environment more severe than in the fabrication steps during use by a user.

Therefore, liquid crystal cells in which under layers uc2 having different thermal expansion coefficients were formed by adding various elements when a silicon nitride film was formed as the color filter under layer uc2 were fabricated, and the breakage rate of the cells was investigated when a heat treatment at a heat curing temperature of 120° C. for the liquid crystal cell seal (sealing material or sealing seal) sl was performed. The result is shown in FIG. 9. The number of specimens is 20 for each condition.

As is apparent from FIG. 9, when the thermal expansion coefficient is about 3 ppm/° C. which is the thermal expansion coefficient of the silicon nitride film as the under layer in forming TFT, the breakage rate is low. However, it is found that the cells easily break when the thermal expansion coefficient exceeds about 15 ppm/° C. This result reveals that the thermal expansion coefficient of the color filter side under layer uc2 is preferably 15 ppm/° C. or less. As to the lower limit of the thermal expansion coefficient, 3 ppm/° C. or more which is substantially the thermal expansion coefficient of the silicon nitride film is effective in a comprehensive manner because the same material as the TFT side under layer uc1 is preferable, and it is difficult to form a film of lower expansion. Since the TFT layer tft mainly includes inorganic films, thermal expansion characteristics of from 3 to 15 ppm/° C. can be easily provided.

From the above result, in the liquid crystal display device of Embodiment 1, the thermal expansion coefficient of the color filter under layer uc2 is from 3 to 15 ppm/° C. Since this can impart characteristics close to the thermal expansion of the TFT layer tft to the CF side substrate pl2, the breakage of the liquid crystal display device can be prevented in the steps or use environment.

As described above, thermocompression bonding is also required when the flexible printed board (connecting line) FPC which connects the not-shown drive circuit with the liquid crystal cell pnl of the invention is connected to the terminal region trm. In this case, a material having a great thermal expansion coefficient is not suitable, and a material having a thermal expansion coefficient in such a range is effectively used also for the TFT under layer uc1 on the TFT side substrate pl1 side. A material having such a thermal expansion coefficient can be formed more easily by using an inorganic material than an organic material.

As described above, in the liquid crystal display device of Embodiment 1, the TFT side substrate pl1 in which the TFT layer tft is bonded to the TFT side resin base material sub1 with the adhesive layer ad1 and the color filter side substrate pl2 in which the color filter under layer uc2 is directly formed on the color filter side resin base material sub2 and the color filter layer cf is formed on the color filter under layer uc2 are arranged to face each other via the liquid crystal layer lc. The thickness of the color filter under layer uc2 is 300 nm. The thermal expansion coefficient of the color filter under layer uc2 is set to from 3 to 15 ppm/° C. Therefore, the thermal expansion characteristics of the CF side substrate pl2 can be brought close to the thermal expansion characteristics of the TFT layer tft. As a result, it is possible to prevent the failure of the liquid crystal display device caused by the thermal expansion difference between the TFT side substrate pl1 and the CF side substrate pl2 in the course of fabrication or use environment. Accordingly, since the lightweight and flexibility of the liquid crystal display device can be improved, it is possible to provide a liquid crystal display device improved in impact resistance or design selectivity for display screen.

### Embodiment 2

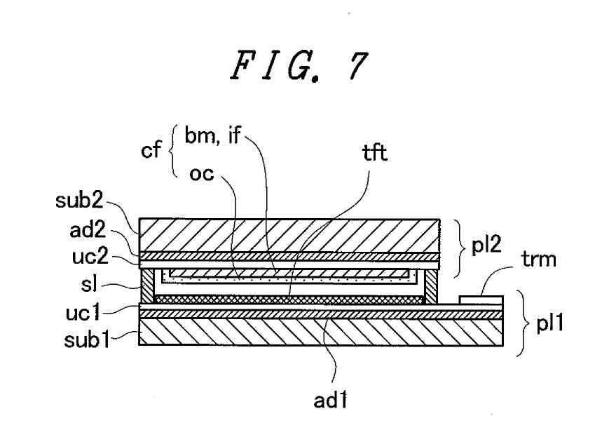

FIG. 7 is a cross sectional view for explaining the detailed configuration of a liquid crystal display device of Embodiment 2 of the invention. In the liquid crystal display device of Embodiment 2, since the configurations other than the configuration of the CF side substrate pl2 are the same as those of the liquid crystal display device of Embodiment 1, the CF side substrate pl2 will be described in detail below.

As shown in FIG. 7, in the liquid crystal display device of Embodiment 2, the CF side substrate pl2 which is obtained by transferring (bonding) the color filter layer cf formed above a not-shown glass base material to the color filter side resin base material sub2 and the TFT side substrate pl1 which is obtained by transferring the TFT layer tft formed above the not-shown glass base material to the TFT side resin base material sub1 are bonded together with the liquid crystal cell seal (sealing seal) sl to form a liquid crystal cell (liquid crystal display device). That is, in the liquid crystal display device of Embodiment 2, the TFT side substrate pl1 and the CF side substrate pl2 are both configured such that the adhesive layer ad1 and an adhesive layer ad2 are respectively formed on the upper surfaces (surfaces on the liquid crystal side) of the resin base materials sub1 and sub2, the under layers uc1 and uc2 are respectively formed on the upper surfaces of the adhesive layers ad1 and ad2, and the TFT layer tft and the color filter layer cf are respectively formed on the upper surfaces of the under layers uc1 and uc2.

Especially on the surface of the CF side substrate (second substrate) pl2 of Embodiment 2, that is, on the liquid crystal layer lc surface side, the adhesive layer (second adhesive layer) ad2 for bonding the color filter layer cf and the color filter side resin base material sub2 together are formed. The color filter under layer uc2 is formed on the adhesive layer ad2. The color filter layer cf formed of the black matrix bm, the colored filter layer if, the overcoat layer oc, and the like is formed on the color filter under layer uc2. Also in Embodiment 2, the liquid crystal cell seal sl is formed on the color filter under layer uc2. Similarly to Embodiment 1, also in Embodiment 2, the liquid crystal cell seal sl is formed so as to overlap the color filter under layer uc2, and at least a part of the liquid crystal cell seal sl is in direct contact with the color filter under layer uc2 annularly. With such a configuration, the influence of contraction or expansion of the color filter side resin base material sub2 which is the base material of the second substrate on the color filter layer cf is suppressed to a minimum.

In the CF side substrate pl2 of Embodiment 2, after the formation of the color filter layer cf on the not-shown glass base material, the color filter layer cf is transferred and formed to the color filter side resin base material sub2. In this manner, the formation of the color filter layer cf on the glass base material hardly causes deformation and enables a high temperature processing. Therefore, it is possible to provide a particular advantage that the color filter layer cf with higher precision and fewer defects can be formed.

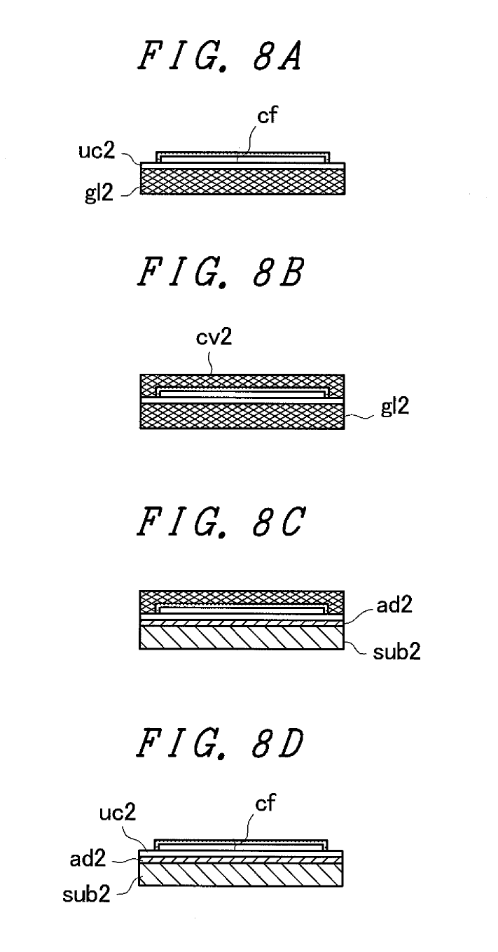

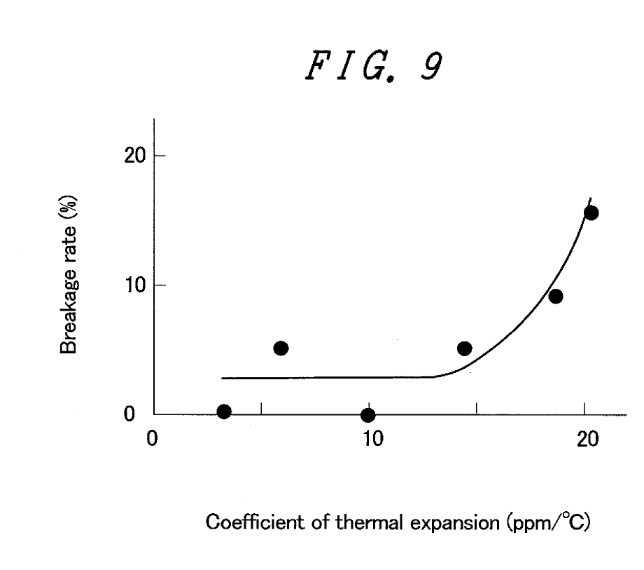

FIGS. 8A to 8D show flow sheets for explaining an embodiment of a fabrication method of the CF side substrate of Embodiment 2 of the invention. Hereinafter, the fabrication method will be described in the order of steps based on FIGS. 8A to 8D. Since thin films including electrodes can be formed in each of the steps by a well-known photolithography technique, the detailed description thereof is omitted.

Step 1. (FIG. 8A)

First, a thin film layer made of silicon nitride added with oxygen is formed on the upper surface of a glass base material (glass base material for forming color filter) gl2 in the drawing as the under layer (color filter under layer) uc2 when the color filter layer cf is formed. The thickness of the color filter under layer uc2 in this case is 300 nm. The amount of an element to be added is controlled such that the thermal expansion coefficient is from 3 to 15 ppm/° C. Since this can impart characteristics close to the thermal expansion of the TFT layer tft to the CF side substrate pl2, the breakage in the steps or use environment can be prevented.

Next, after the black matrix bm and the colored filter layers if of R (red), G (green), and B (blue) are formed on the color filter under layer uc2 using an existing high temperature process, the overcoat layer oc is formed so as to cover the black matrix bm and the colored filter layers if, whereby the color filter layer cf is formed.

Step 2. (FIG. 8B)

Next, a thin film layer serving as a color filter layer protective base material cv2 is formed on the upper surface side of the glass base material gl2 in the drawing so as to cover the overcoat layer oc. Next, the glass base material gl2 is removed by chemical polishing (chemical etching) using, for example, an etching solution mainly containing hydrofluoric acid by using the color filter layer protective base material cv2 as a supporting material. In this case, since the color filter under layer uc2 is resistant to hydrofluoric acid, the glass base material gl2 is removed in chemical polishing. The material of the color filter under layer uc2 is not limited to silicon nitride but may be other film material although a material which is resistant to hydrofluoric acid is preferable. The removing of the glass base material gl2 is not limited to chemical polishing, but mechanical polishing or a polishing method combining mechanical polishing and chemical polishing may be used, for example.

Step 3. (FIG. 8C)

Next, the color filter layer cf supported by the color filter layer protective base material cv2 after removing the glass base material gl2 is bonded to the color filter side resin base material sub2 with the adhesive layer ad2. With the step 3, the color filter side resin base material sub2 constitutes the base material of the CF side substrate pl2.

Step 4. (FIG. 8D)

Next, the color filter layer protective base material cv2 formed on the color filter layer cf is peeled, whereby the transfer of the color filter layer cf formed on the glass base material gl2 to the color filter side resin base material sub2 is completed. In this manner, in Embodiment 2, the color filter layer cf is transferred together with the color filter under layer uc2 to the color filter side resin base material sub2 upon transfer.

As described above, in the liquid crystal display device of Embodiment 2, the TFT side substrate pl1 in which the TFT layer tft is bonded onto the TFT side resin base material sub1 with the adhesive layer (first adhesive layer) ad1 and the CF side substrate pl2 in which the color filter layer cf is bonded onto the color filter side resin base material sub2 with the adhesive layer ad2 are arranged to face each other via the liquid crystal layer lc. The thickness of the color filter under layer uc2 is 300 nm. The thermal expansion coefficient of the color filter under layer uc2 is set to from 3 to 15 ppm/° C. Therefore, the thermal expansion characteristics of the CF side substrate pl2 can be brought close to the thermal expansion characteristics of the TFT layer tft. As a result, it is possible to prevent the failure of the liquid crystal display device caused by the thermal expansion difference between the TFT side substrate pl1 and the CF side substrate pl2 in the course of fabrication or use environment. Accordingly, since the lightweight and flexibility of the liquid crystal display device can be improved, it is possible to provide the liquid crystal display device improved in impact resistance or design selectivity for display screen.

### Embodiment 3

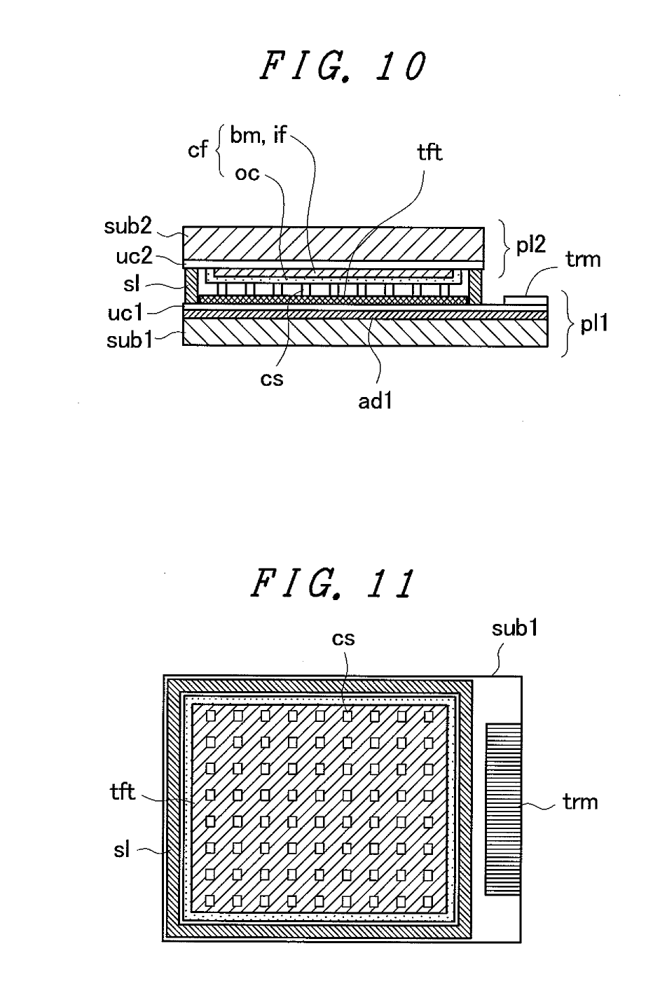

FIG. 10 is a cross sectional view for explaining the schematic configuration of a liquid crystal display device of Embodiment 3 of the invention. FIG. 11 is a plan view for explaining the arrangement position of column spacers of the liquid crystal display device of Embodiment 3 of the invention. In the liquid crystal display device of Embodiment 3, since the configurations other than the configuration of column spacers cs are the same as those of the liquid crystal display device of Embodiment 1, the column spacers cs will be described in detail below. Since the column spacers can be formed by a well-known photolithography technique, the detailed description thereof is omitted.

As shown in FIG. 10, the liquid crystal display device of Embodiment 3 is configured in the same manner as the liquid crystal display device of Embodiment 1. That is, the CF side substrate pl2 in which the color filter layer cf is formed on the color filter side resin base material sub2 and the TFT side substrate pl1 which is obtained by transferring the TFT layer tft formed above the not-shown glass base material to the TFT side resin base material sub1 are bonded together with the liquid crystal cell seal (sealing seal) sl to form a liquid crystal cell (liquid crystal display device).

In addition to the configuration, in the liquid crystal display device of Embodiment 3, the column spacers cs are arranged in a matrix in the display region between the TFT side substrate pl1 and the CF side substrate pl2. That is, in the liquid crystal display device of Embodiment 3, the column spacers cs having the same height as the distance (cell gap) between the TFT side substrate pl1 and the CF side substrate pl2 are formed in the region where the liquid crystal is filled. In this manner, the column spacers cs arranged in a matrix are included in the sealed region of the liquid crystal.

As is apparent from FIG. 11, the column spacers cs in the liquid crystal display device of Embodiment 3 are arranged in a matrix so as to be parallel to the vertical and horizontal directions in the drawing, that is, the vertical and horizontal directions of the liquid crystal display device, similarly to the arrangement direction of the pixels.

Accordingly, in the liquid crystal display device of Embodiment 3, even when the TFT layer tft and the color filter layer cf are formed on resin substrates which easily deform compared with a glass substrate, the column spacers cs can maintain (control) the cell gap at a constant distance. Accordingly, in addition to the advantage of the liquid crystal display device of Embodiment 1, it is possible to provide a particular advantage that uniform display can be performed in the display region without causing display failure such as display unevenness even when a force is applied from the outside to the liquid crystal display device. The arrangement direction of the column spacers cs is not limited to the arrangement direction of the pixels. The column spacers cs may be arranged in a matrix in other direction.

The CF side substrate pl2 of the liquid crystal display device of Embodiment 3 of the invention may be configured as the CF side substrate pl2 of Embodiment 2. Also in this case, the above-described advantage can be provided. The column spacers cs may be formed on the side of the color filter side substrate pl2 or the side of the TFT side substrate pl1.

What is claimed is:

1. A liquid crystal display device including a first substrate and a second substrate which are arranged to face each other via a liquid crystal layer, the first substrate and the second substrate each being formed of a resin base material, comprising:
an adhesive layer which is formed on the liquid crystal layer side of the first substrate to fix a liquid crystal drive layer formed with pixels in a matrix to the first substrate; and
an under layer which is formed between a light shielding film and a colored filter layer both corresponding to each of the pixels and the second substrate and formed of a thin film material having a thermal expansion coefficient smaller than that of the second substrate.

2. A liquid crystal display device including a first substrate and a second substrate which are arranged to face each other via a liquid crystal layer, the first substrate and the second substrate each being formed of a resin base material, comprising:
a first adhesive layer which is formed on the liquid crystal layer side of the first substrate to fix a liquid crystal drive layer formed with pixels in a matrix to the first substrate;
a second adhesive layer which is formed on the liquid crystal layer side of the second substrate to fix a color filter layer formed with a light shielding film and a colored filter layer both corresponding to each of the pixels to the second substrate; and
an under layer which is formed on the liquid crystal layer side of the color filter layer and formed of a thin film layer having a thermal expansion coefficient smaller than that of the second substrate.

3. The liquid crystal display device according to claim 1, wherein
the under layer is formed of a thin film layer having a thermal expansion coefficient of from 3 to 15 ppm/° C.

4. The liquid crystal display device according to claim 1, wherein
a sealing material which fixes the first substrate to the second substrate and the under layer are formed so as to overlap with each other, at least a part of the sealing material being in close contact with the under layer annularly.

5. The liquid crystal display device according to claim 1, wherein
the under layer is resistant to hydrofluoric acid.

6. The liquid crystal display device according to claim 1, wherein
the under layer is a thin film layer formed of an inorganic material.

7. The liquid crystal display device according to claim 6, wherein
the under layer is a thin film layer formed of nitride.

8. The liquid crystal display device according to claim 1, wherein
the under layer is a thin film layer formed of a material containing oxygen.

9. The liquid crystal display device according to claim 1, wherein
the under layer is formed of a thin film layer having a thickness of 300 nm or more.

10. A method for fabricating a liquid crystal display device including a first substrate and a second substrate which are arranged to face each other via a liquid crystal layer, the first substrate and the second substrate each being formed of a resin base material, the method comprising:
forming a light shielding film and a colored filter layer both corresponding to a pixel and a protective film above a first base material having a heat resistance greater than that of the resin base material;
forming a protective base material which supports and protects the light shielding film, the colored filter layer, and the protective film on an upper surface side of the first base material;
removing the first base material chemically and/or mechanically;
fixing the light shielding film, the colored filter layer, and the protective film from which the first base material is removed to the first substrate via an adhesive layer; and
removing the protective base material from above the light shielding film, the colored filter layer, and the protective film which are fixed to the first substrate.
